(19) United States
(12) Patent Application Publication
(10) Pub. No.: US 2005/0141957 A1
(43) Pub. Date: Jun. 30, 2005

(54) FIXTURE FOR SECURING AN UMBRELLA TO A CHAIR

(76) Inventor: Chao-Lin Chen, Shinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/743,913

(22) Filed: Dec. 24, 2003

(51) Int. Cl. F16B 2/02

(52) U.S. Cl. 403/290

(57) ABSTRACT

A fixture for securing an umbrella to a chair includes a first clip, a second clip, a connector nod, a pulling rod, a cam rod, a pin, and a spring. The pin is inserted through the spring and connects with the first clip and the second clip at respective ends. The first clip has a hole at the center. The connector nod has a spherical socket at one end and a connecting end at the opposite end. The spherical socket has an opening at the outer end and a notch at one side and a ditch at the opposite side thereof. The notch is interconnected with the opening. The ditch extends all the way to the connecting end, which urges the connecting end to insert into the hole of the first clip. The pulling rod is inserted through the first clip and the second clip and connected with the cam rod at one end.

### FIELD OF THE INVENTION

This invention relates to a fixture for securing an umbrella to a chair.

### BACKGROUND OF THE INVENTION

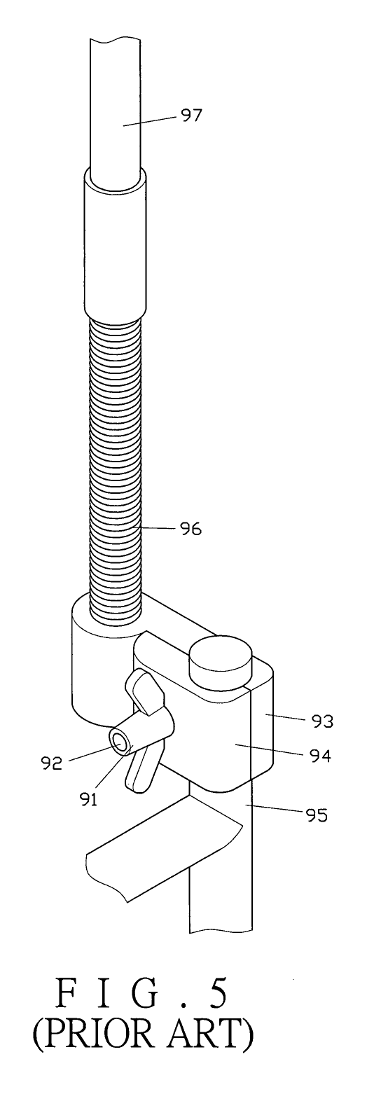

An umbrella outdoor chair mostly can be seen at the beach or at the movie shooting area used by the director. The umbrella is secured on the chair by a butterfly nut 91 and a bolt 92 with a pair of clips 93 and 94, as shown in FIG. 5. The clip 93 is connected with a gooseneck pipe 96 coupled with a skeleton 97 of the umbrella on the top end thereof. The gooseneck pipe 96 allows adjusting the skeleton 97 to a desired angel. However, this design is inconvenient and requires a higher cost in manufacture.

The inventor has therefore derived the present invention to improve the above-mentioned and many other shortcomings.

### SUMMARY OF THE INVENTION

It is the primary object of the present invention to provide a fixture for securing an umbrella to a chair, which is easy to operate.

It is another object of the present invention to provide a fixture for securing an umbrella to a chair, which is inexpensive in manufacture.

It is a further object of the present invention to provide a fixture for securing an umbrella to a chair, which is easy to mount and dismount.

### FIELD OF THE INVENTION

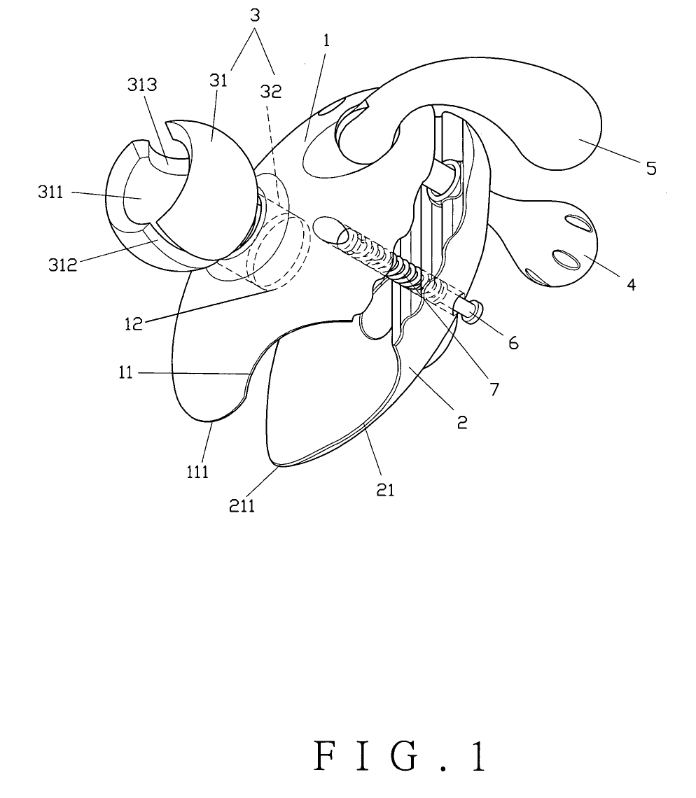

FIG. 1 is a perspective view of the present invention;

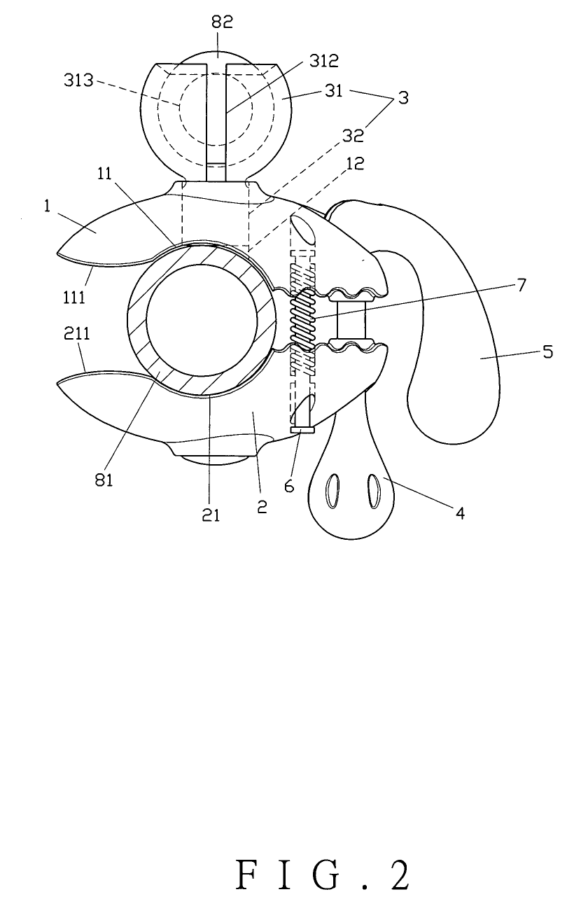

FIG. 2 is a side view of the present invention, partial sectioned;

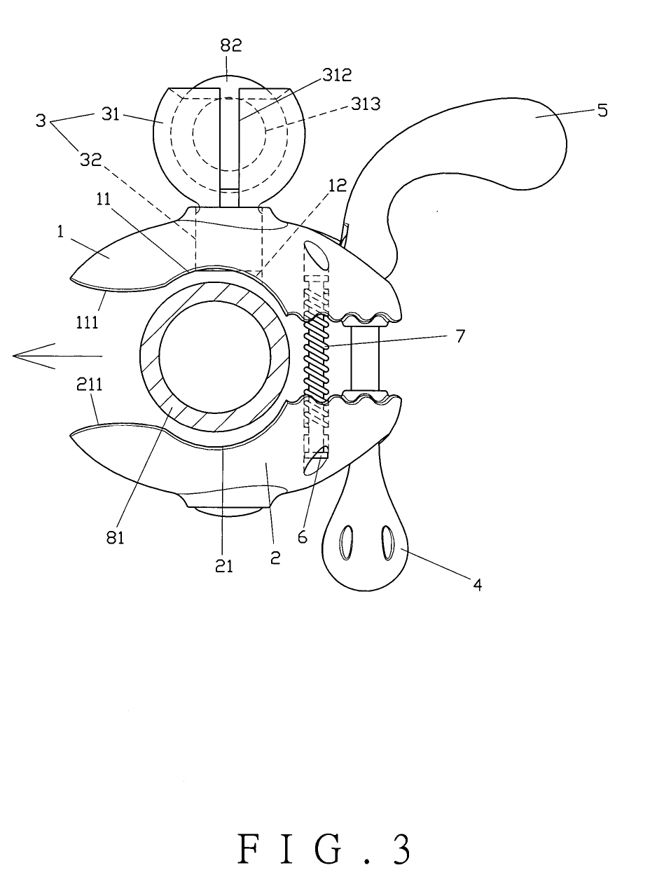

FIG. 3 is a view depicting the release of a cam rod of the present invention;

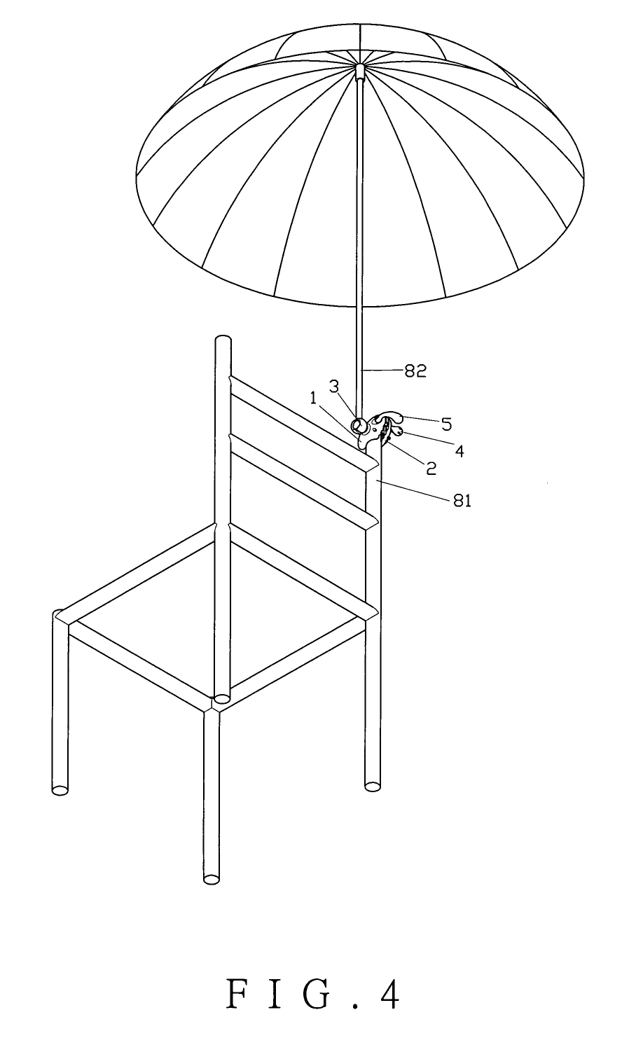

FIG. 4 is a view showing the present invention incorporated with a chair, and

FIG. 5 is perspective view of a prior art.

### DETAILED DESCRIPTION OF THE PREFERRED EMBODIMENT

As shown in FIGS. 1 and 2, the present invention comprises a first clip 1, a second clip 2, a connector nod 3, a pulling rod 4, a cam rod 5, a pin 6 and a spring 7.

The first clip 1 has an arcuate recess 11 at one side with a notch 111 at one side of the recess 11. The second clip 2 also has an arcuate recess 21 at one side with a notch 211 at one side of the recess 21. The first clip 1 has a hole 12 at one side.

The connector nod 3 has a spherical socket 31 at one end and a cone-shaped connecting end 32 at the other end. The spherical socket 31 has an opening 311 at the outer end, a notch 313 at one side and a ditch 312 at the opposite side thereof. The notch 313 and the opening 311 are interconnected The ditch 312 extends to the connecting end 32.

The pin 6 is inserted through the spring 7 with its two ends connected with the first clip 1 and the second clip 2, respectively.

The connecting end 32 of the connector nod 3 is inserted into the hole 12 of the first clip 1. The pulling rod 4 is also inserted through the first clip 1 and the second clip 2 and connected with the cam rod 5. The cone-shaped connecting end 32 with the ditch 312 is urged to insert into the hole 12 of the first clip 1.

By pulling or pushing the cam rod 5, as shown in FIGS. 2 and 4, the pulling rod 4 links the first clip 1 and the second clip 2 to clamp a chair frame, 81, which brings the opening 311 and the notch 313 of the spherical socket 31 to clamp an umbrella rod 82. The connecting end 32 can be spun in the hole 12 of the first clip 1, which links the spherical socket 31 to spin simultaneously and brings the opening 311 to adjust the angle of the umbrella rod 82. This enables the umbrella rod 82 adjustable both in direction and angle by adjusting the spherical socket 31. When the cam rod 5 is released to loosen the pulling rod 4, as shown in FIG. 3, the first clip 1 and the second clip 2 are urged by the spring 7 to disengage the chair frame 81 and dismount the umbrella rod 82.

1. A fixture for securing an umbrella to a chair comprising a first clip, a second clip, a connector nod, a pulling rod, a cam rod, a pin and a spring, both said first clip and said second clip having an arcuate recess at one side corresponding to each other, said pin being inserted through said spring and connected with said first clip and said second clip at respective ends thereof, said first clip having a hole at a center, said connector nod comprising a spherical socket at one end and a connecting end at another end thereof, said spherical socket having an opening at an outer end, a notch at one side and a ditch at an opposite side, said notch being interconnected with said opening, said ditch extending to said connecting end and forcing said connecting end into said hole of said first clip, said pulling rod being inserted through said fist clip and said second clip and connected with said cam rod at one end, by pulling or pushing said cam rod to close or release said first clip and said second clip.

2. The fixture for securing an umbrella to a chair, as recited in claim 1, wherein said connecting end of said connector nod is in a cone shape.
